(19) United States
(12) Patent Application Publication
(10) Pub. No.: US 2014/0236793 A1
(43) Pub. Date: Aug. 21, 2014

(54) Business And Professional Network System And Method For Identifying Prospective Clients That Are Unlikely To Pay For Professional Services

(71) Applicants: David J. Matthews, Bedminster, NJ (US); John A. Kellam, Basking Ridge, NJ (US)

(72) Inventors: David J. Matthews, Bedminster, NJ (US); John A. Kellam, Basking Ridge, NJ (US)

(21) Appl. No.: 13/815,296

(22) Filed: Feb. 19, 2013

(51) Int. Cl. G06Q 40/00

(52) U.S. Cl. CPC G06Q 40/00
USPC 705/35

(57) ABSTRACT

A business network system identifies prospective clients having delinquent accounts open with subscribers, including businesses or professionals, of the network system. The business network system associated with software provides entry of subscriber information within a subscriber database storing subscriber registration and client information and networking subscriber information. A client database is promulgated through the client information from the subscriber. The client database stores payment history information associated with at least one subscriber of the database. The payment history includes entry of any outstanding account balances owed by the client to any of the subscribers. Advantageously, the client database lists non-paying clients so that the subscribers can elect to avoid taking on the client as a perspective client and refuse to perform services for the client.

### BACKGROUND OF THE INVENTION

1. Field of the Invention

The present invention relates to systems and methods for mitigating losses by determining the payment history of prospective clients.

2. Description of the Prior Art

Every year businesses and professionals deal with payment issues and delinquent accounts for goods or services performed on behalf of clients. Losses to businesses owing to delinquent accounts are substantial and can cause extreme hardship to the businesses and professionals. Losses not only result from the failure of a client, customer, or patient from paying, but loss of time that would be better spent on paying clientele, customers and patients. Despite lack of payment, the services rendered or goods produced in expectation of payment require the outlay by business owners of salaries to technicians and office personnel associated with the services, as well as disbursements for materials required for production of the goods.

Current systems and methods employ credit checks through known credit bureau reporting agencies when the business or professional is determining whether to extend a line of credit. Generally credit checks involve inquiring credit bureau or consumer reporting agencies, or credit reference agencies that collect information from various sources and provide consumer credit information on individual consumers. Credit checks from these organizations provide information on individuals' borrowing and bill-paying habits. However, in the vast majority of cases when professional services are being performed and a line of credit is not being extended, professionals do not require perspective clients/customers to undergo formal credit checks. Formal credit checks are not generally performed by professionals and businesses such as law firms, doctor offices, dentists, architects, and the like. Indeed, most prospective clients/customers would immediately be turned-off from a professional business if such extensive credit checks were required for services and/or goods. Unfortunately, all too often upon completion of the services and/or delivery of the goods the customer/client refuses to pay, or simply ignores billing statements.

Though various systems and methods have been provided for businesses in determining whether to extend credit or in determining interest rates and the like, heretofore known and utilized systems and methods utilize formal credit checks which are not practical for use by professional businesses. Use of such formal credit checking is not desirous by professionals, such as dentists, doctors, lawyers, and the like, to verify that the client will pay for the services, as these procedures may be seen as counterintuitive to building client relationships.

Examples of various systems and methods which generally utilize known credit report techniques are set forth hereinbelow:

U.S. Pat. No. 3,316,395 to Lavin discloses credit risk computers employing sources of electrical energy, electrical circuit elements and electrosensitive indicating means to perform and display the computations.

U.S. Pat. No. 5,313,463 to Gore et al. discloses a credit checking system wherein a business performs a credit check on a customer's credit card number by utilizing the D-channel of an Integrated Services Digital Network (ISDN) facility. The ISDN facility connects the business to a telecommunications network, which utilizes signaling system number 7 (SS7). Specifically, the ISDN Q.931 protocol is modified to allow the Q.931 FACILITY message to include: a) credit check request, b) a call reference number, and c) the customer's credit card number.

U.S. Pat. No. 5,491,817 to Gopal et al. discloses an online linking method implementation which includes an interconnection network, which employs a standard directory protocol, such as X.500, and linking components. The interconnection network includes interfaces for interconnection users and local directories. The linking components include linking directories and linking applications which are connected to the interconnection network via interfaces. Linking directories contain entries, and each entry comprises linking references pointing to entities, which include local directories and linking applications and have access to information about the object in different contexts. In the linking directory, there is an entry for each object, and this entry is accessible using a linking identifier unique to the object. The linking application coordinates a response to the user's request and sends queries to the linking directory, local directories, and other linking applications to fulfill user's requests. In summation, retrieved information is formatted by the linking application and forwarded to the user in response to the request.

U.S. Pat. No. 5,732,400 to Mandler et al. discloses a system and method for enabling on-line transactional services among sellers and buyers having no previous relationship with each other. The system includes a financial clearinghouse for receiving a request for goods or services from a buyer and making a real-time determination of a risk classification of the buyer utilizing an on-line repository of credit information. The financial clearinghouse determines a risk-based discount fee as a function of the buyer's risk classification in order to establish a payment amount to the seller from the clearinghouse.

U.S. Pat. No. 6,112,190 to Fletcher et al. discloses a method and system for assimilating data, applying reasoning mechanisms, and emulating the thought processes of a credit officer for commercial credit analysis. The system aids a credit officer in the risk assessment and completion of a loan package. The system thereby improves loan turnaround time and customer service, improving loan servicing capacity, quality, and consistency of credit decisions, and reducing costs. The system includes: 1) a conventional data base management system subsystem that manages and collects data via electronic access and end-user data entry; and 2) a decision support expert system that applies a knowledge base and inference engine (collectively known as an assessment model) utilizing an evidence tree and a generalized weighting approach to analyze credit requests.

U.S. Pat. No. 6,311,169 to Duhon discloses a consumer credit information data base controlled by a computerized system for storing current consumer credit information, as well as historical credit data information. The computerized system is programmed to present current and historical credit data information to on-line users so that better assessments can be made as to the credit worthiness of a consumer.

U.S. Pat. No. 6,321,206 to Honarvar discloses a software-based decision management system that allows an organization to monitor and evaluate client performance data relating to client interactions with the organization, and to appropriately modify organizational strategies in accordance with the performance data. More specifically, the system (a) applies different strategies to different categories of clients of the organization, (b) tracks the performance of the clients as a result of the applied strategies, and (c) refines the applied strategies based on the tracked performance to increase client value over time to the organization. It teaches a software-based decision management system that allows an organization to monitor and evaluate client performance data relating to client interactions with the organization, and to appropriately modify organizational strategies in accordance with the performance data.

U.S. Pat. No. 6,405,173 to Honarvar et al. discloses a computer-implemented decision management system which provides qualitative client assessment via point in time simulation. More specifically, the decision management system (a) simulates the effect of a strategy by applying the strategy to client data, and (b) tracks what type of client traveled through a respective decision point in the strategy during the simulation.

U.S. Pat. No. 6,405,181 to Lent et al. discloses a system and method for providing real time approval of credit over a network. The method includes obtaining applicant data from an applicant. The applicant data is analyzed into a form suitable for directly obtaining a credit report from a credit bureau for the applicant. A credit report having credit report data is obtained from a credit bureau for the applicant. It is then determined whether to accept the applicant using the credit report data and it is communicated to the applicant that the applicant has been approved.

U.S. Pat. No. 6,513,018 to Culhane discloses an apparatus and methods for generating a score predictive of the likelihood of a desired performance result for a selected receiver of that performance from a selected performer that includes memory means storing performance information of the selected performer for the selected receiver and storing matched performance information over the same relevant time interval of the selected performer for all receivers of similar performance; calculating means developing for the performer at least one first continuous variable of the performance for all receivers other than the selected receiver; calculating means developing for the performer at least one second continuous variable of the performance for the selected receiver; and accumulation means developing a performance score for the desired performance result from the first and second continuous variables.

U.S. Pat. No. 6,847,942 to Land et al. discloses an accounts Receivable System's Credit Inquiry Module that reviews payment history and performs credit inquiries by analyzing data from internal and external sources. The Credit Inquiry Module uses this analysis for credit management and customer contact. The Credit Inquiry Module based on customer payment data predicts overall cash forecasting for the client. The Credit Inquiry Module is utilized for account reconciliation and audit verification for tracking transactions at the customer level.

U.S. Pat. No. 7,747,517 to Sugano et al. discloses a commercial credit scoring method which enables a perfectly anonymous commercial transaction on a site built on a computer network. A person intended to newly participate as a seller or purchaser in a commercial transaction on the site is certified as a transactor when the person satisfies a given condition. A rank of the certified transactor is determined based on a given company data including at least one of a capital, sales amount, and transaction history about the transactor. A transaction limit in the transaction of the transactor is determined based on the rank, and a restraint is placed on the transaction when the amount of the transaction exceeds the transaction limit of the seller or purchaser.

U.S. Pat. No. 8,126,772 to Lefebvre discloses a robust rebate cross-sell network in which business entities, including financial institutions, can make targeted offers, including pre-approved or pre-qualified credit offers, to a desirable consumer utilizing information submitted by the consumer during a rebate redemption process. These business entities may but need not be associated with a rebate-issuing entity (i.e., rebate sponsor) or a rebate processing center which processes rebate claims for the rebate sponsor. In one embodiment, a cross-sell network manager can determine the consumer's identity, look-up the consumer at credit bureau(s), and perform a passive, real-time inquiry. Contingent upon a plurality of factors (e.g., the results of the inquiry or look-up against the pre-approved/qualified customer list, etc.), one or more targeted offers are identified. A Web page can be dynamically generated with the selectively identified offers and presented to the consumer as disbursement options, perhaps after authenticating the consumer's identity.

Foreign Publication No. EP 1271370 to Sugano et al. discloses a commercial credit scoring method, which enables a perfectly anonymous commercial transaction on a site built on a computer network. The method comprises the steps of: certifying as a transactor a person intended to participate as a seller or purchaser newly in a commercial transaction on said site when the person satisfies a given condition; determining a rank of said certificated transactor based on a given company data including at least one of a capital, sales amount, and transaction history about said transactor; determining a transaction limit in said transaction of said transactor based on the rank; and placing a restraint on said transaction when the amount of said transaction exceeds said transaction limit of said seller or purchaser. In a preferred embodiment, it is possible to perform an electronic commerce entirely in a perfectly anonymous manner including the business talk, contract, settlement, and delivery.

Even wherein business networks are heretofore disclosed and utilized, these business networks do not provide information as to client/customer payment histories. For example, Non-Patent Literature “Local Business—Global Network®” found at http://www.bni.com/ discloses a business networking and referral service. The service only takes one person per professional specialty in a chapter. The publication's primary objective is to assist its members in ways to improve their business and to educate them concerning how they can effectively network. It provides a forum that allows members to meet other business peers who need to know effective and efficient business people.

The various methods and systems heretofore disclosed and utilized generally teach systems and methods utilizing credit reporting techniques which are overly intrusive in forming a client-professional relationship. Further, even when business networks are provided, these business networks are generally merely utilized for networking and gaining customer referrals and the like, but are not utilized as a financial tool for the networked businesses.

None of the methods and systems teach a business network that is utilized by its members to identify prospective clients that are unlikely to pay for professional services/goods without the need to perform an invasive credit check on the client/customer.

Notwithstanding the efforts of prior art workers to provide improvements in business accounts receivables, there clearly exists a need in the art for a system and method that provides a business network wherein businesses can share client payment history with one another. Further, there exists a need in the art for a system and method that enables a business to immediately recognize a client as presenting a high risk of non-payment, and which allows the business to determine whether to perform services for the prospective client immediately upon client contact with the professional/business. There additionally exists a need in the art for a system and method that is non-intrusive to the client, does not require extensive credit check inquiries, and allows professionals and businesses to prevent taking on non-paying clients at the point of initial consultation.

### SUMMARY OF THE INVENTION

The present invention relates to a business network system for identifying prospective clients having delinquent accounts that remain open with subscribers, including businesses or professionals, of the network system. The business network system provides improvements in business accounts receivables and business bottom lines as it prevents bad debt from entering at the point of client inception. Through the business network system, professionals and businesses can share client payment history with one another. The system enables a business to immediately recognize a client that presents a high risk of non-payment, and thus allows the business to determine whether to perform services for the prospective client immediately upon client contact with the professional/business. Furthermore, the subject business network system is non-intrusive to the client, does not require extensive credit check inquiries, and allows professionals and businesses to prevent taking on non-paying clients at the point of initial consultation.

The business network system for identifying prospective clients unlikely to pay for professional services and/or goods comprises a database in communication with a plurality of personal database systems, the database having a storage device, Internet connectivity, and a local database. The database is associated with software that provides entry of subscriber information within a subscriber database storing subscriber registration and client information and networking subscriber information. A client database is promulgated through the client information from the subscriber, the client database storing payment history information associated with at least one subscriber of the database. The payment history includes entry of any outstanding account balances owed by the client to any of the subscribers. The subscriber database includes a plurality of businesses or sole proprietor members having access to the database. Advantageously, the client database lists non-paying clients so that the subscribers can elect to avoid taking on the client as a perspective client and refuse to perform services for the client. Further provided are embodiments wherein a subscriber that identifies a client listed as having a delinquent account can collect payment owed on that account and remit the payment to the subscriber to whom the delinquent payment is owed.

Additionally, a non-transitory computer readable electronic storage medium is provided that stores one or more programs comprising instructions executable by an electronic device having a screen display and Internet capability to cause the device to: display a business network. The displayed business network is associated with software that provides entry of client information for identifying prospective clients that are unlikely to pay for professional services and/or goods. The business network includes a database associated with software that provides entry of subscriber information within a subscriber database storing subscriber registration and client information and networking subscriber information. A client database is promulgated through the client information from the subscriber, the client database stores payment history information associated with at least one subscriber of the database. The payment history includes entry of any outstanding account balances owed by the client to any of the subscribers. The subscriber database includes a plurality of businesses or sole proprietor members having access to the database.

Further provided is a method of using a business network system by a professional or business for identifying prospective clients that are unlikely to pay for professional services and/or goods, comprising the steps of: (i) logging onto the business network system, the system comprising: a database in communication with an plurality of personal database systems, the database having a storage device, Internet connectivity, and a local database; the database associated with software that provides entry of subscriber information within a subscriber database storing subscriber registration and client information and networking subscriber information; a client database promulgated through the client information from the subscriber, the client database storing payment history information associated with at least one subscriber of the database; and the payment history including entry of any outstanding account balances owed by the client to any of the subscribers; the subscriber database including a plurality of businesses or sole proprietor members having access to the database; whereby the client database lists non-paying clients so that the subscribers can elect to avoid taking on the client as a perspective client and refuse to perform services for the client; (ii) listing previous client information concerning clients who have delinquent accounts, where applicable; (iii) searching for a perspective client's name to determine if the client is located on the client database; and (iv) refusing services to the client if the client has a delinquent account with another subscriber.

### BRIEF DESCRIPTION OF THE DRAWINGS

The invention will be more fully understood and further advantages will become apparent when reference is made to the following detailed description of the preferred embodiments of the invention and the accompanying drawing, in which:

FIG. 1 illustrates a schematic view of the business network system platform implementing software for identifying prospective clients that are unlikely to pay for professional services and/or goods;

FIG. 2 illustrates a screen shot summary of a page showing client information concerning a perspective client for a subscriber when using the subject business network system for identifying a prospective client to determine whether that client has outstanding accounts with another subscriber;

FIG. 3 illustrates a flow chart schematic of the subject business network system and method; and

FIG. 4 illustrates a system chart for the subject business network system.

### DETAILED DESCRIPTION OF THE INVENTION

The subject business network is directed to a system and method for identifying prospective clients having delinquent accounts open with subscribers, including businesses or professionals, of the network system. One of the main tenets of the subject business network system is premised on the position that the best way to eliminate a bad debt is to prevent it from ever entering one's office/business. Through the business network system prospective bad debt is identified by identifying prospective clients that are unlikely to pay for professional services and/or goods. Subscribers to the deadbeat database service, in turn, preferably pay a monthly fee and have access to a database containing potential customers with a demonstrative poor payment history.

The business network system, associated with software, provides entry of subscriber information within a subscriber database storing subscriber registration and client information and networking subscriber information. A client database is promulgated through the client information from the subscriber. The client database stores payment history information associated with at least one subscriber of the database. The payment history includes entry of any outstanding account balances owed by the client to any of the subscribers. Advantageously, the client database lists non-paying clients so that the subscribers can elect to avoid taking on the client as a perspective client and refuse to perform services for the client.

Impact of delinquent accounts can vastly affect the business operation. Though various systems and methods have been provided for businesses in determining whether to extend credit or in determining interest rates and the like, heretofore known and utilized systems and methods utilize formal credit checks which are not practical for use by professional businesses. A business may ask to check the credit of a potential client, customer or patient; but many potential clients would consider this an intrusion and would decline such checking. Moreover, credit reporting boroughs tend to create negative credit score marks in cases where there are more than a few credit checks on a person. Such credit reports are also provided for financial lending services, renting, job application, and the like, and are not generally provided where a line of credit or a position governing finances it not being extended. Use of such formal credit checking is not desirous by professionals, such as dentists, doctors, lawyers, and the like, to verify that the client will pay for the services, as this procedure may be seen as counterintuitive in building client relationships. The various methods and systems heretofore disclosed and utilized generally teach systems and methods utilizing credit reporting techniques which are overly intrusive and adversely affect formation of client-professional relationships.

It is not feasible for a credit check to be performed for each potential client, customer or patient for business owners in the regular course of business dealings. The subject business network provides a system and method for businesses to review the payment history of potential new clients, customers, patients, and the like for services or goods, so that the business can make an educated assessment regarding credit worthiness when taking-on the new client and risk associated therewith. Business/professional subscribers come together through the system and either refuse services to non-paying clients and/or demand payment on past accounts contingent upon future services/goods.

The present invention is directed to a business network system for identifying prospective clients having delinquent accounts open with subscribers, including businesses or professionals, of the network system. The business network system provides improvements in business accounts receivables and business bottom lines as it prevents bad debt from entering at the point of client inception. Through the business network system professionals and businesses can share a potential client's payment history with one another. It enables a business to immediately recognize a client that carries a high risk of non-payment, and thus allows the business to determine whether to perform services for the prospective client immediately upon client contact with the professional/business. Furthermore, the subject business network system is non-intrusive to the client, does not require extensive credit check inquiries, and allows professionals and businesses to prevent taking on non-paying clients at the point of initial consultation.

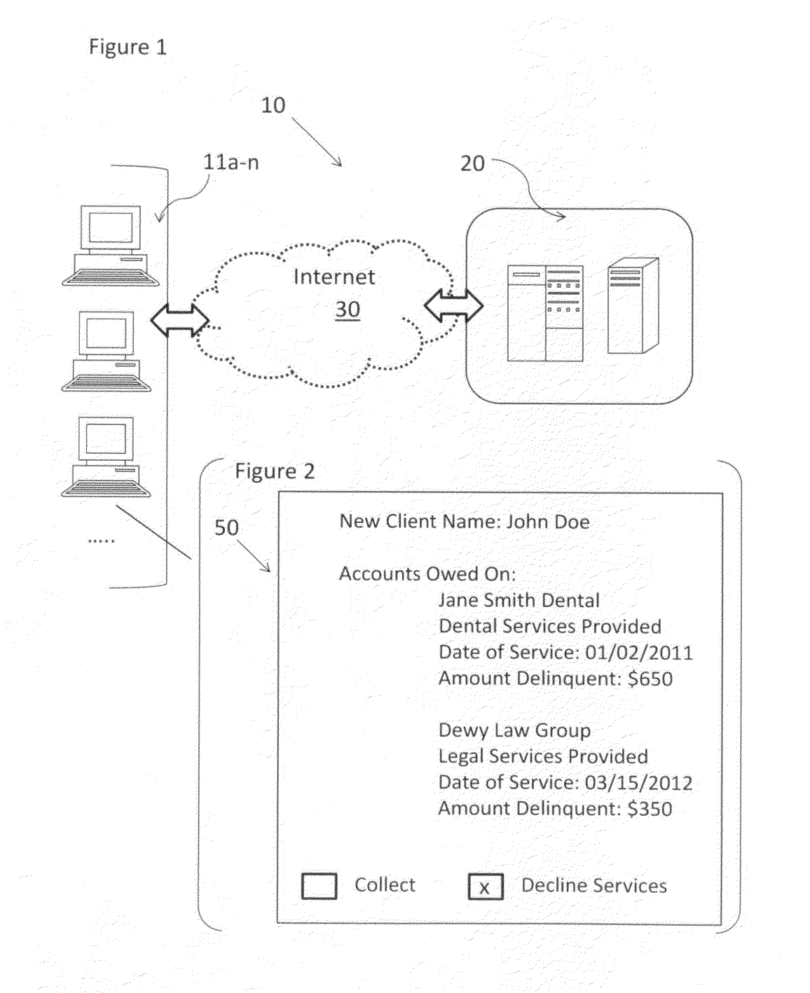

FIGS. 1 and 2 illustrate a schematic view of the subject business networking system and method generally at 10, and an example of a screen show shown at 50, respectively. FIG. 1 illustrates a schematic view of the business network system platform implementing software for identifying prospective clients that are unlikely to pay for professional services and/or goods. FIG. 2 illustrates a screen shot summary of a page showing client information concerning a perspective client for a subscriber when using the subject business network system for identifying a prospective client to determine whether that client has outstanding accounts with another subscriber.

Generally, the database 10 includes a remote database 20 in communication with a plurality of user computers 11 a-n via Internet 30. The database 20 provides each subscriber business with a unique identification number. The database 20 includes a list of customers/clients/patients collectively referred to as “New Client”. This listing of “New Client” includes any previous information concerning the potential client that is available on the database through information provided by the subscribers. The database 20 is a remote Internet database or local database, in communication with the personal computer database systems 11a-n of the subscribers so that upon entry of a “New Client” name a search is conducted on the database to retrieve payment history. The database 20 and user computers 11a-n have Internet connectivity, a local database, an internal subscriber and new client database, display monitor, memory, processor, and software generated or hardware data entry.

The business network database provides a monthly subscription service that offers daily updates of potential new clients, customers, patients, and the like, that have not paid for services/products/goods provided to them. As a subscriber of the database subscription service, the subscriber will be able to identify a non-paying client immediately when they initially contact the office. The subscriber has the ability through the database to collect past debts owed to other subscribers as well as block this potential new customer from becoming a bad debt in the subscriber's accounts receivable.

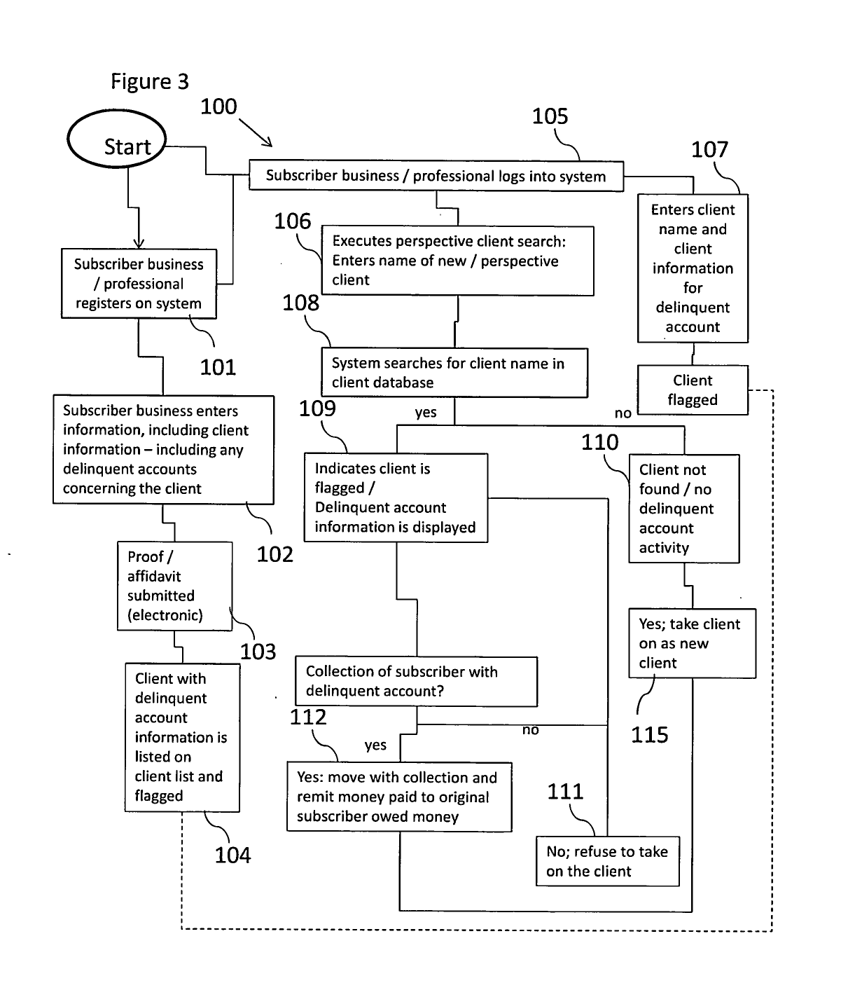

FIG. 3 illustrates a flow chart schematic of the subject business network system and method, shown generally at 100. New subscriber business/professional registers on the system at 101. Upon registering, a unique identifier code is provided in association with the subscriber business. Subscriber business enters information, including client information—including any delinquent accounts concerning the client at 102. Preferably, evidentiary proof in the form of at least one invoice copy, etc. is required; or in the alternative, an affidavit supporting the delinquent status may be filed electronically at 103. The delinquent client is then listed/registered on a client list or delinquent client list and is flagged as having delinquent status at 104. Next or existing subscribers, log into the system at 105. Upon logging in the subscriber can execute a client search to determine whether the perspective client has any delinquent accounts as set forth at 106 or the subscriber can enter/update the client list at 107 by adding a newly delinquent client to the list 104. Wherein the subscriber executes a perspective client search, the subscriber enters the name/entity of the perspective new client at 108. If the client name does not match any on the list/the client does not have any delinquent accounts with subscriber members as indicated at 110, the subscriber can comfortably move forward to perform services for the client on a low risk level, as indicated at 115. Alternatively, if the client name matches that on the list 104 promulgated from input from all subscribers, delinquency is indicated/the client is flagged at 109. As flagged, further information is provided as to the subscriber owed money, the amount, the date, the nature of the services, and/or whether the client has made any attempt at payment or has made any payments to the bill. Upon such indication, the subscriber member can then decide whether to simply refuse services at 111; or alternatively, can elect to move for collection of subscriber-owed payments with delinquent account at 112. If the subscriber elects to move for collection of the monies owed at 112, then the subscriber attempts to collect the delinquent amount and remits any money paid to the subscriber to whom the collected monies were originally owed. In the event that the client pays the money owed at 112, the subscriber can then elect to take on the client and perform the services, etc. for the client at 115. If the client still refuses to pay, the subscriber refuses to perform work/services for the client back to 111.

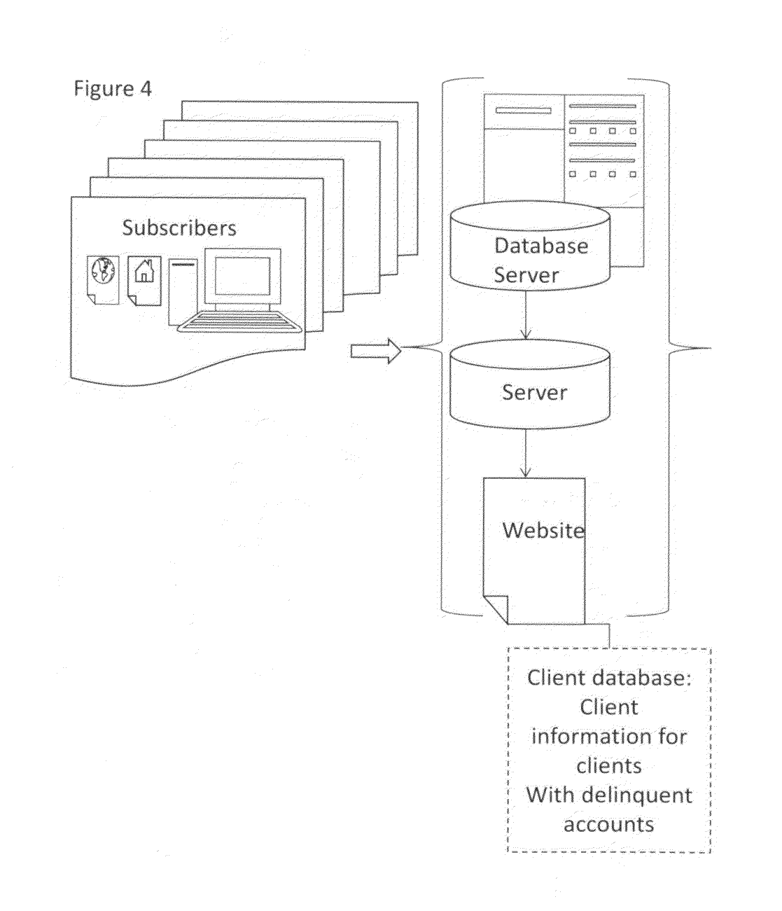

FIG. 4 illustrates a system chart for the subject business network system, illustrating the system hardware implementing the software in communication via the Internet with personal database systems (computers, etc.) of the subscribers.

Obligations of the subscriber of the database preferably include: (i) Payment of monthly subscription fee; (ii) Subscriber must pledge to not treat anyone on the ‘Deadbeat Database listing that has delinquent payments, without first collecting all past due amounts owed to other subscribers of the database; (iii) Subscribers must report all collections made from non-paying clients/customers to the database and forward the proceeds to the rightful owner (subscriber); (iv) Subscribers must supply detailed information on any person, family, company that has stiffed the Subscriber for money in the past. The subscriber will be asked to provide proof of such an account that is in arrears as well as to sign an affidavit of proof. Falsification of such information by any subscriber will render that subscriber subject to prosecution as allowed by law, and/or may be used to prevent that subscriber from continued participation in the Deadbeat Database program.

In an alternate embodiment of the system, collection of all past due amounts owed to other subscribers of the database is not mandatory. Subscribers are encouraged to collect past due amounts owed to other subscribers and to report all collections made from non-paying clients/customers to the database and forward the proceeds to the rightful owner (subscriber), but need not pledge to do so. In addition, Subscribers are encouraged to supply detailed information on any person, family, company that has stiffed the Subscriber for money in the past.

Having thus described the invention in rather full detail, it will be understood that such detail need not be strictly adhered to, but that additional changes and modifications may suggest themselves to one skilled in the art, all falling within the scope of the invention as defined by the subjoined claims.

What is claimed is:

1. A business network system for identifying prospective clients that are unlikely to pay for professional services and/or goods, comprising:
a. a database in communication with a plurality of personal database systems, said database having a storage device, Internet connectivity, and a local database;
a. said database being associated with software that provides entry of subscriber information within a subscriber database storing subscriber registration and client information and networking subscriber information;
b. a client database promulgated through said client information from said subscriber, said client database storing payment history information associated with at least one subscriber of said database;
c. said payment history including entry of any outstanding account balances owed by said client to any of said subscribers;
d. said subscriber database including a plurality of businesses or sole proprietor members having access to said database;
whereby said client database lists non-paying clients so that said subscribers can elect to avoid taking on said non-paying client as a perspective client and refuse to perform services for said client.

2. The business network system as recited in claim 1, comprising a monthly subscription service that offers daily updates of potential new clients, customers, patients, etc., which have not paid for services/products/goods provided to them.

3. The business network system as recited in claim 1, comprising a collection means for collection of past debts owed to other subscribers of said system.

4. The business network system as recited in claim 1, comprising a blocking function for blocking potential new customer from becoming a bad debt in the account receivable.

5. The business network system as recited in claim 1, comprising a pledge function wherein said subscriber is prompted to pledge not to treat any clients/patients/customers listed on the system that has delinquent payments.

6. The business network system as recited in claim 5, wherein said pledge is includes a prompt for collection of all past due amounts owed to other subscribers of said database from said client.

7. The business network system as recited in claim 5, wherein said subscribers must report all collections made from non-paying clients/customers via a collections report in said database and forward proceeds collected to the rightful subscriber.

8. The business network system as recited in claim 1, wherein said client information submitted by said subscribers includes detailed information on any person, family, company that has failed to pay for services and/or goods rendered.

9. The business network system as recited in claim 1, wherein said client information includes a proof submission function.

10. The business network system as recited in claim 1, wherein said client information includes an affidavit.

11. The business network system as recited in claim 1, wherein a mobile application is provided that enables communication of said system on a smart phone or mobile tablet device.

12. The business network system as recited in claim 1, wherein a credit check is not carried out.

13. The business network system as recited in claim 1, wherein client information includes services/goods rendered to the client, client name, past dealings with the client, and the amount of monies outstanding for services/goods rendered.

14. A non-transitory computer readable electronic storage medium storing one or more programs comprising instructions executable by a electronic device having a screen display and Internet capability to cause the device to: display a business network associated with software that provides entry of client information for identifying prospective clients that are unlikely to pay for professional services and/or goods, said business network, comprising:
a. a database associated with software that provides entry of subscriber information within a subscriber database storing subscriber registration and client information and networking subscriber information;
b. a client database promulgated through said client information from said subscriber, said client database storing payment history information associated with at least one subscriber of said database;
c. said payment history including entry of any outstanding account balances owed by said client to any of said subscribers;
d. said subscriber database including a plurality of businesses or sole proprietor members having access to said database.

15. A method of using a business network system by a professional or business for identifying prospective clients that are unlikely to pay for professional services and/or goods, comprising the steps of:
a. logging onto said business network system, said system comprising:
i. a database in communication with a plurality of personal database systems, said database having a storage device, Internet connectivity, and a local database;
ii. said database being associated with software that provides entry of subscriber information within a subscriber database storing subscriber registration and client information and networking subscriber information;
iii. a client database promulgated through said client information from said subscriber, said client database storing payment history information associated with at least one subscriber of said database;
iv. said payment history including entry of any outstanding account balances owed by said client to any of said subscribers;
v. said subscriber database including a plurality of businesses or sole proprietor members having access to said database;
whereby said client database lists non-paying clients so that said subscribers can elect to avoid taking on said client as a perspective client and refuse to perform services for said client;
b. listing previous client information concerning clients who have delinquent accounts, where applicable;
c. searching for a perspective client's name to determine if said client is located on said client database;
d. refusing services to said client if said client has a delinquent account with another subscriber.
